(19) United States
(12) Patent Application Publication
(10) Pub. No.: US 2010/0088480 A1
(43) Pub. Date: Apr. 8, 2010

(54) SYSTEM AND METHOD FOR STORING DATA IN A MOBILE DEVICE

(75) Inventor: Chih-Wei Hu, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Chi Mei Communication Systems, Inc., Tu-Cheng City (TW)

(21) Appl. No.: 12/346,874

(22) Filed: Dec. 31, 2008

(30) Foreign Application Priority Data
Oct. 6, 2008 (CN) 200810304742.8

(51) Int. Cl. G06F 12/16; G06F 12/00; G06F 11/14; G06F 12/02

(52) U.S. Cl. 711/161; 711/171; 714/8; 711/166; 714/E11.113; 711/E12.001; 711/E12.103

(57) ABSTRACT

A method for storing data in a mobile device includes initializing a memory of the mobile device when the mobile device is powered on, allocating a free block of memory from the memory, saving received new data in the free block, and allocating a new free block again from the memory for saving received new data next time. The method further includes prompting for sufficient memory space to be manually freed from the memory if the new free block allocation is a failure, and re-prompting for sufficient memory space to be manually freed from the memory until a preset prompt time has been prompted if sufficient memory space has not been manually freed, or allocating a new free block of memory from the memory if sufficient memory space has been manually freed.

### BACKGROUND

1. Field of the Invention

Embodiments of the present disclosure relate to systems and methods for managing data, and particularly to a system and method for storing data in a mobile device.

2. Description of Related Art

In our modern information-oriented society, compact-sized mobile phones are broadly utilized by people in daily life. Mobile phones can be used to communicate with each other via telephones or short messages almost anytime and anywhere. Often, if storage space of the mobile phone is full and is not released in time, new received data will fail to be stored promptly or even lost. In one method, an extra storage, e.g., an electrically erasable read only memory (E2PROM), may be used to store the new received data if a main storage of the mobile phone is full.

However, the above-mentioned method is inconvenient for a programmer to manage the extra storage of the mobile phone. For example, if the user wants to delete data stored in the extra storage, the data needs to be first copied to the main storage of the mobile phone before deletion.

What is needed, therefore, is an improved system and method for storing data in a memory of a mobile device, which can overcome the aforementioned problem.

### BRIEF DESCRIPTION OF THE DRAWINGS

FIG. 1 is a schematic diagram of one embodiment of a system for storing data in a mobile device;

FIG. 2 is a block diagram of one embodiment of a data processing unit shown in FIG. 1; and

FIG. 3 is a flowchart of one embodiment of a method for storing data in a mobile device.

### DETAILED DESCRIPTION OF CERTAIN INVENTIVE EMBODIMENTS

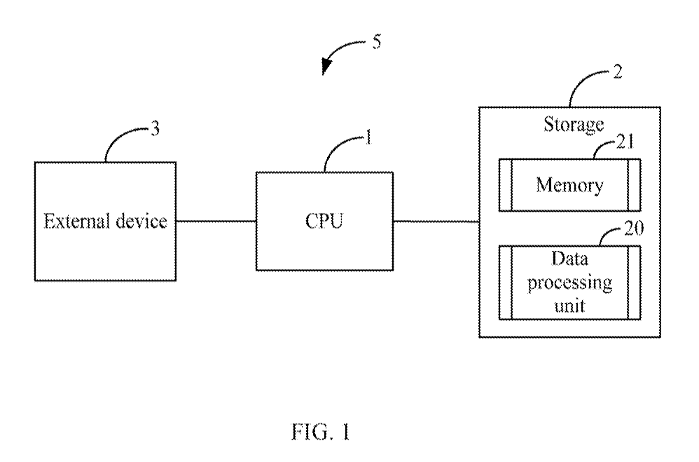

All of the processes described below may be embodied in, and fully automated via, software code modules executed by one or more general purpose mobile devices or processors. The code modules may be stored in any type of readable medium or other storage device. Some or all of the methods may alternatively be embodied in specialized hardware. Depending on the embodiment, the readable medium may be a hard disk drive, a compact disc, a digital video disc, or a tape drive. FIG. 1 is a schematic diagram of one embodiment of a system 5 for storing data in a mobile device. In one embodiment, the system 5 includes a central processing unit (CPU) 1, a storage 2, and an external device 3. The CPU 1 is connected with the storage 2 and the external device 3. In one embodiment, the storage 2 includes a data processing unit 20 and a memory 21. The memory 21 may be a flash memory and the external device 3 may include a liquid crystal display (LCD) and a keyboard. In one embodiment, the mobile device may be a cell phone, a digital camera, or a personal digital assistant (PDA).

The CPU 1 is configured for controlling execution of the data processing unit 20. The data processing unit 20 is configured for reserving a free block in the memory 21, saving received new data in the free block, and reserving a new free block again for receiving new data received next time.

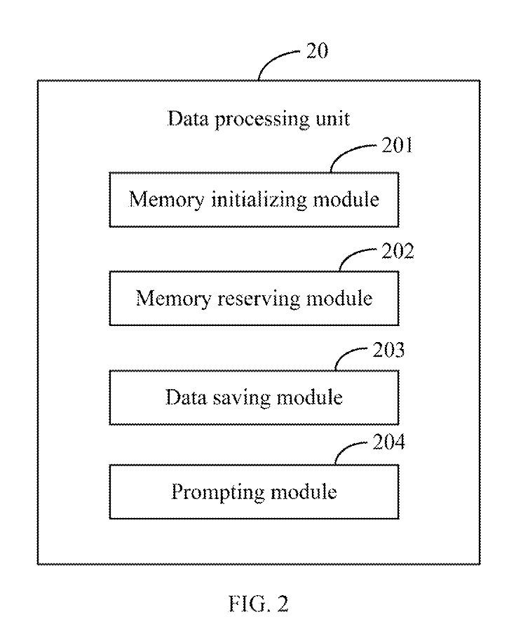

FIG. 2 is a block diagram of one embodiment of the data processing unit 20 shown in FIG. 1. In one embodiment, the data processing unit 20 includes a memory initializing module 201, a memory reserving module 202, a data saving module 203, and a prompting module 204.

The memory initializing module 201 is configured for initializing the memory 21 of the mobile device when the mobile device is powered on.

The memory reserving module 202 is configured for allocating a free block of memory from the memory 21. In one embodiment, a block size of the free block is pre-determined.

The data saving module 203 is configured for saving received new data in the free block.

The memory reserving module 202 is further configured for allocating a new free block of memory from the memory 21, and detecting if the new free block allocation is a success or a failure. In one embodiment, the memory reserving module 202 determines that allocating the new free block fails if a total free space of the memory 21 is less than the block size.

The prompting module 204 is configured for prompting for sufficient memory space to be manually freed from the memory 21 if the new free block allocation is a failure.

The memory reserving module 202 is further configured for detecting if sufficient memory space has been manually freed from the memory 21 for the received new data, and also determining a preset prompt time. In one embodiment, the memory reserving module 202 determines that sufficient memory space has not been manually freed if a total free space of the memory 21 after being manually freed is less than the block size. In one embodiment, the preset prompt time may be defined as the number of times that the memory reserving module 202 prompts a user to free sufficient memory space manually from the memory 21 in response to receiving new data. The number of times may be three times in one exemplary embodiment.

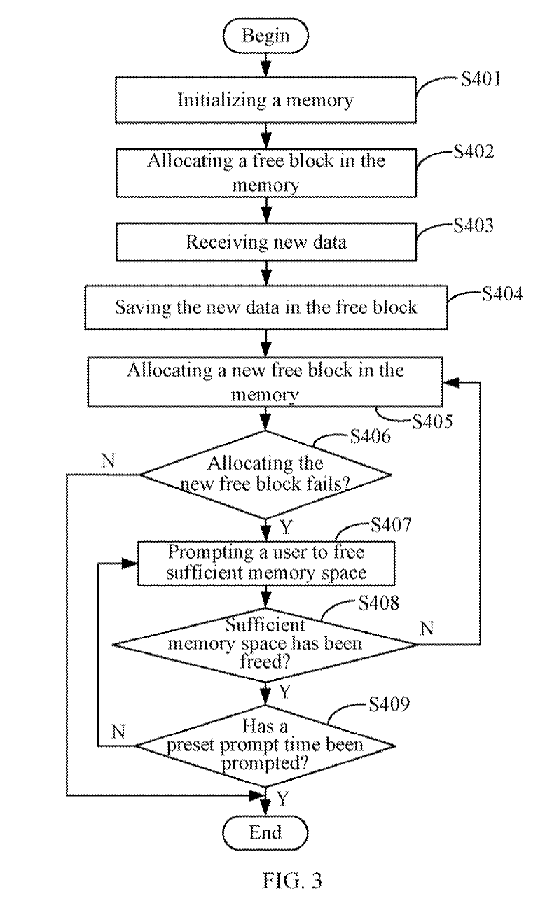

FIG. 3 is a flowchart of one embodiment of a method for storing data in a mobile device. Depending on the embodiment, additional blocks may be added, others removed, and the ordering of the blocks may be changed.

In block S401, the memory initializing module 201 initializes the memory 21 of the mobile device when the mobile device is powered on.

In block S402, the memory reserving module 202 allocates a free block of memory from the memory 21. In one embodiment, a block size of the free block may be predetermined, such as one megabyte

In block S403, the mobile device receives new data. In one embodiment, the new data may be a short message or a multimedia message service (MMS).

In block S404, the data saving module 203 saves the new data in the free block.

In block S405, the memory reserving module 202 allocates a new free block of memory from the memory 21 again for receiving new data received next time.

In block S406, the memory reserving module 202 detects if the new free block allocation is a success or a failure. In one embodiment, the memory reserving module 202 determines that allocating the new free block fails if a total free space of the memory 21 is less than the block size. If the new free block allocation is a failure, the process goes to block S407. Otherwise, the process ends if the new free block allocation is a success.

In block S407, the prompting module 204 prompts for sufficient memory space to be manually freed from the memory 21.

In block S408, the memory reserving module 202 detects if sufficient memory space has been manually freed from the memory 21 for the received new data. In one embodiment, the memory reserving module 202 determines that sufficient memory space has not been manually freed if a total free space of the memory 21, after being manually freed, is less than the block size. If sufficient memory space has not been manually freed, the process goes to block S409. Otherwise, the process goes to block S405 if sufficient memory space has been manually freed.

In block S409, the memory reserving module 202 determines if a preset prompt time has been prompted. If the preset prompt time has been prompted, the process ends. Otherwise, the process goes to block S407 if the preset prompt time has not been prompted. In other words, the memory reserving module 202 re-prompts a user to manually free sufficient memory space from the memory 21 until the preset prompt time has been prompted.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for storing data in a mobile device, the method comprising:
initializing a memory of the mobile device when the mobile device is powered on;
allocating a free block of memory from the memory, wherein a block size of the free block is pre-determined;
saving received new data in the free block, and allocating a new free block of memory from the memory;
prompting for sufficient memory space to be manually freed from the memory if the new free block allocation is a failure; and
re-prompting for sufficient memory space to be manually freed from the memory until a preset prompt time has been prompted if sufficient memory space has not been manually freed, or allocating a new free block of memory from the memory if sufficient memory space has been manually freed.

2. The method according to claim 1, wherein the step of allocating the new free block fails upon the condition that a total free space of the memory is less than the block size.

3. The method according to claim 1, wherein sufficient memory space has not been manually freed is determined upon the condition that a total free space of the memory after being manually freed is less than the block size.

4. The method according to claim 1, wherein the preset prompt time is defined as the number of times to prompt a user to manually free sufficient memory space from the memory in response to receiving the new data.

5. The method according to claim 1, wherein the mobile device is selected from the group consisting of a cell phone, a digital camera, and a personal digital assistant (PDA).

6. A storage medium having stored thereon instructions that, when executed by a processor of a mobile device, causes the processor to perform a method for storing data in the mobile device, the method comprising:
initializing a memory of the mobile device when the mobile device is powered on;
allocating a free block of memory from the memory, wherein a block size of the free block is pre-determined;
saving received new data in the free block, and allocating a new free block of memory from the memory;
prompting for sufficient memory space to be manually freed from the memory if the new free block allocation is a failure; and
re-prompting for sufficient memory space to be manually freed from the memory until a preset prompt time has been prompted if sufficient memory space has not been manually freed, or allocating a new free block of memory from the memory if sufficient memory space has been manually freed.

7. The medium according to claim 6, wherein the medium is selected from the group consisting of a hard disk drive, a compact disc, a digital video disc, and a tape drive.

8. A system for storing data in a mobile device, comprising:
a memory initializing module configured for initializing a memory of the mobile device when the mobile device is powered on;
a memory reserving module configured for allocating a free block of memory from the memory, wherein a block size of the free block is pre-determined;
a data saving module configured for saving received new data in the free block;
the memory reserving module further configured for allocating a new free block of memory from the memory, and detecting if the new free block allocation is a success or a failure;
a prompting module configured for prompting for sufficient memory space to be manually freed from the memory if the new free block allocation is a failure; and
the memory reserving module further configured for detecting if sufficient memory space has been manually freed from the memory, and also determining a preset prompt time.

9. The system according to claim 8, wherein the memory reserving module determines that allocating the new free block fails if a total free space of the memory is less than the block size.

10. The system according to claim 8, wherein the memory reserving module determines that sufficient memory space has not been manually freed if a total free space of the memory after being manually freed is less than the block size.

11. The system according to claim 8, wherein the preset prompt time is defined as the number of times to prompt a user to manually free sufficient memory space from the memory in response to receiving the new data.

12. The system according to claim 8, wherein the mobile device is selected from the group consisting of a cell phone, a digital camera, and a personal digital assistant (PDA).
